(19) United States
(12) Patent Application Publication
(10) Pub. No.: US 2026/0298683 A1
(43) Pub. Date: Oct. 1, 2026

(54) SYSTEM AND METHOD FOR CARBON EMISSION REDUCTION

(71) Applicant: GE DIGITAL HOLDINGS LLC, Cambridge, MA (US)

(72) Inventors: Veerappan M, Bengaluru (IN); Rahul PRABHU, Bangalore (IN); Sundararam RATHOD, Bengaluru (IN); Shashanka DUTTA, Bangalore (IN); Bhargavi LENKA, Bangalore (IN)

(21) Appl. No.: 19/092,720

(22) Filed: Mar. 27, 2025

(51) Int. Cl. G01F 9/00; G01F 1/42

(52) U.S. Cl. CPC G01F 9/006; G01F 1/42

(57) ABSTRACT

According to some embodiments systems and methods are provided including a data store storing an electronic record for each of a plurality of fuel measurement units, wherein each electronic record includes an uncertainty value for the fuel measurement unit; a memory storing processor-executable program code; and a processing unit to execute the processor-executable program code to cause the system to: receive fuel flow data from three types of fuel measurement units, wherein the fuel is flowing from a fuel source to an asset system; generate a reconciled fuel flow for the asset system using the received fuel flow data from the three types of fuel measurement units; generate a reconciled uncertainty value for the asset system using the uncertainty value for the respective fuel measurement units; and generate an emission value for the asset system based on the reconciled fuel flow. Numerous other aspects are provided.

### BACKGROUND

Greenhouse gas (GHG) emissions are emissions from human activities that trap heat in the atmosphere and contribute to climate change. Non-exhaustive examples of greenhouse gases are carbon dioxide, methane, nitrous oxide, and fluorinated gases. GHG emissions are often measured in carbon dioxide equivalent. To convert emissions of a gas into carbon dioxide equivalent, its emissions are multiplied by the gas's Global Warming Potential (GWP). The GWP takes into account the fact that many gases are more effective at warming the Earth than carbon dioxide, per unit mass. Often, enterprises may report their GHG emissions to governments (e.g., Environment Protection Agency (EPA), Federal, State, etc.), shareholders, the public and other third parties. Conventionally, GHG emissions are determined based on fuel consumption. As such, if the measured fuel consumption is not accurate, then the calibration of GHG emissions based on the fuel consumption is inaccurate.

It would therefore be desirable to increase the accuracy of the measure of fuel consumption, thereby increasing the accuracy of the GHG emissions.

### SUMMARY

According to some embodiments, systems and methods are provided to accurately and/or automatically determine a measured fuel consumption and a GHG emission based on the measured fuel consumption in a way that provides fast and useful results and that allows for flexibility and effectiveness when implementing those results.

According to some embodiments, a computing system may include a data store storing an electronic record for each of a plurality of fuel measurement units, wherein each electronic record includes an uncertainty value for the fuel measurement unit; a memory storing processor-executable program code; and a processing unit to execute the processor-executable program code to cause the system to: receive fuel flow data from three types of fuel measurement units, wherein the fuel is flowing from a fuel source to an asset system; generate a reconciled fuel flow for the asset system using the received fuel flow data from the three types of fuel measurement units; generate a reconciled uncertainty value for the asset system using the uncertainty value for the respective fuel measurement units; and generate an emission value for the asset system based on the reconciled fuel flow.

According to an aspect of another example embodiment, a method may include receiving fuel flow data from three types of fuel measurement units, wherein the fuel is flowing from a fuel source to an asset system; generating a reconciled fuel flow for the asset system using the received fuel flow data from the three types of fuel measurement units; generating a reconciled uncertainty value for the asset system using the uncertainty value for the respective fuel measurement units; generating an emission value for the asset system based on the reconciled fuel flow; and transmitting the reconciled fuel flow to a model based controller.

A technical effect of some embodiments of the invention is an improved and computerized way to measure fuel consumption and GHG emissions. With these and other advantages and features that will become hereinafter apparent, a more complete understanding of the nature of the invention can be obtained by referring to the following detailed description and to the drawings appended thereto.

### BRIEF DESCRIPTION OF THE DRAWINGS

FIG. 1 is a high-level block diagram of a system in accordance with some embodiments.

FIG. 2 illustrates a method in accordance with some embodiments.

FIG. 3 is a high-level block diagram of fuel flow in accordance with some embodiments.

FIG. 4 illustrates a more detailed method in accordance with some embodiments.

FIG. 5 illustrates a more detailed block diagram of fuel flow in accordance with some embodiments.

FIG. 6 illustrates a table for a non-exhaustive example of a unit level reconciliation in accordance with some embodiments.

FIG. 7 illustrates a table of non-exhaustive measurement values and final reconciliated values for each time period in accordance with some embodiments.

FIG. 8 illustrates a block diagram in accordance with some embodiments.

FIG. 9 illustrates a table for a non-exhaustive example of a plant level reconciliation in accordance with some embodiments.

FIG. 10 illustrates a block diagram of an apparatus in accordance with some embodiments

FIG. 11 illustrates a tablet computer displaying a GHG emission report user interface in accordance with some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate the reduction of uncertainty in the determination of used fuel, which in turn is used in the generation of fuel-based emissions. Increased accuracy in determining fuel consumption results in operations of machinery and activities in a way to better meet emission targets and protect the environment against climate change. The present invention is directed to more than merely a computer implementation of a routine or conventional activity previously known in the industry as it significantly advances the technical efficiency between devices (e.g., gas turbine, model based controller, digital twin, etc.) by implementing a specific new method and system as defined herein. The present invention is a specific advancement in the area of GHG emissions by providing benefits in improved accuracy, and detection of fuel-based carbon emissions, and such advances are not merely a longstanding commercial practice. The present invention provides improvement beyond a mere generic computer implementation as it involves the processing and conversion of significant amounts of data in a new beneficial manner.

As described above, Greenhouse gas (GHG) emissions are emissions from human activities that trap heat in the atmosphere and contribute to climate change. Non-exhaustive examples of greenhouse gases are carbon dioxide, methane, nitrous oxide, and fluorinated gases. GHG emissions are often measured in carbon dioxide equivalent.

Often, enterprises report their GHG emissions to governments (e.g., Environment Protection Agency (EPA), Federal, State, etc.), shareholders, the public and other third parties. For example, shareholders and the public may want to know whether an enterprise is contributing to climate change, and if so, by how much.

In some cases, enterprises are required by government regulations to report GHG emissions. For example, those facilities that emit 25,000 metric tons or more of GHG per year; certain suppliers of fossil fuels, industrial GHGs, and products containing GHGs; and facilities that inject carbon dioxide underground, are required by the GHG Reporting Program (GHGRP) to report their emissions.

As part of the reporting, the emissions may also be tracked for enterprises to participate in the carbon trade. In some cases, governments authorize the carbon trade (e.g., buying and selling of carbon credits) with the goal of gradually reducing overall carbon emissions and mitigating their contribution to climate change. The carbon trade is the buying and selling of carbon credits that permit an enterprise or other entity to emit a certain amount of carbon dioxide or other greenhouse gas. The carbon trade is a cap and trade government regulatory program designed to limit, or cap, the total level of emissions of certain chemicals, particularly carbon dioxide, as a result of industrial activity. The government sets the limit, or cap, on emissions permitted across a given industry. With this program, the government issues a set amount of permits to enterprises that comprise a cap on allowed emissions, typically carbon dioxide. Enterprises that surpass the cap are taxed, while enterprises that cut their emissions may sell or trade unused credits.

Conventionally, GHG emissions may be measured by continuous emission monitoring system (CEMS) or by using emission factors.

CEMS measure emissions from a source, not the fuel itself; it continuously monitors the concentration of pollutants in the emitted gas, providing data on the actual emission levels from a stationary source like a smokestack, rather than the characteristics of the fuel being burned. CEMS may determine a gas or particulate matter concentration or emission rate using pollutant analyzer measurements and a conversion equation, graph, or computer program to produce results in units of applicable emission limitation or standard. CEMS are required under some government regulations (e.g., Environmental Protection Agency (EPA)) for either continual compliance determinations or determination of exceedances of the standards. Sensors and/or other devices may be used by the CEMS to directly measure the emissions.

An emission factor is a representative value that attempts to relate the quantity of a pollutant released to the atmosphere with an activity associated with the release of that pollutant. In other words, an emission factor is a number that represents how much of a pollutant is released into the atmosphere for each unit of an activity. Emission factors are used to calculate the amount of GHG emissions specific activity or process. These factors are usually expressed as the weight (or mass) of pollutant (e.g., carbon dioxide) divided by a unit weight, volume, distance, duration of the activity emitting the pollutant or material input (e.g., kilograms of particulate (e.g., carbon dioxide) emitted per megagram of coal burned). To estimate emissions, an emission factor is multiplied by the corresponding activity data such as the production output of a manufacturing plant, the energy contained in a mass of fuel combusted, or the amount of electricity consumed. Activity data is converted to match the units used by the particular emission factor to calculate the GHG emissions, and then the activity data is multiplied by the emission factor to equal the GHG emissions.

With emission monitoring, it is important to accurately calculate the emissions produced by an enterprise. Emissions are highly influenced by the amount of fuel used during the activity. For example, the more fuel that is burned, the more emissions that are generated. As used herein, “fuel” refers to any substance that can be burned to create energy. Gasoline or natural gas are examples of fuel. As such, emission calculations using emission factors may be highly influenced by an amount of fuel used. To that end, if the fuel measurement is not accurate, then the emission calculation based on the fuel input (e.g., the amount of fuel consumed), will also be inaccurate.

To address these problems, the Fuel Flow Reconciliator (FFR) provided by embodiments automatically and dynamically executes fuel-based reconciliation at both a unit level and a plant level. As described above, since emissions are highly dependent on the amount of fuel (and the content or composition of the fuel), it is important to have the best measurement of the amount of fuel. “Unit level” herein refers to a particular unit (e.g., a gas turbine) that consumes the fuel and generates GHG emissions. At the unit level, the FFR receives three-inputs—a flow meter (e.g., via a sensor) input of the amount of fuel flowing to the gas turbine, which is a rate of volume per time, the control valve input, which is a digitally calibrated measurement on the amount of fuel let in to the gas turbine, and another digitally calibrated sensor (e.g., a digital twin) input for fuel measurement. The FFR first reconciles the flow meter input with the control valve input, resulting in a first reconciliated value. The FFR then reconciles the first reconciliated value with the digitally calibrates sensor input to output a best measurement (“final reconciliated fuel flow value”). In particular, at the unit level, the FFR, executes a three-way reconciliation using an orifice meter, a control valve position-based flow and a digital twin (using an Adaptive Real-Time Engine Simulation (ARES) from GE® for a gas turbine) to determine the reconciled fuel flow. The measurements of the three fuel measurement units are leveraged to give a better estimation of the fuel input to the gas turbine, reducing uncertainty of the measurements, according to embodiments. After outputting the final reconciled fuel flow, this value may be used to calculate the output emissions of the unit. At the plant level (e.g., one or more gas turbines), the FFR combines the reconciled fuel flow measurements from the units (e.g., gas turbines) and a fuel flow measurement from a Coriolis meter to further reduce uncertainty. Pursuant to embodiments, the total fuel flow uncertainty may be reduced from 4% to 1.15% at the unit level, and at the plant level, the unit level uncertainty is further reduced to 0.82%. Higher uncertainty levels result in the enterprise producing less power or engaging in other emission-producing activity to ensure the enterprise stays under the limit. As such, the reduction in uncertainty provides the enterprise with more variability to produce more or less power and/or sell or buy more power while keeping within the emission limits. Additionally, increased accuracy/reduced uncertainty allows enterprises to make more informed choices with respect to operation of the units, for example, and better protect and maintain the environment.

Throughout the following, embodiments are described with respect to a gas turbine as a non-exhaustive example of the asset system. Embodiments apply to other suitable asset systems. A gas turbine is a combustion engine that, in some instances, is at the heart of a power plant and converts natural gas or other liquid fuels to mechanical energy. This energy then drives a generator that produces the electrical energy that moves along power lines to homes and businesses. In particular, the gas turbine uses fuel that gets burned, via a combustion process, to heat the air and increase the pressure. The increased pressure makes the turbine rotate, resulting in the generator attached to the turbine producing electricity. The generation of this energy also generates GHG emissions.

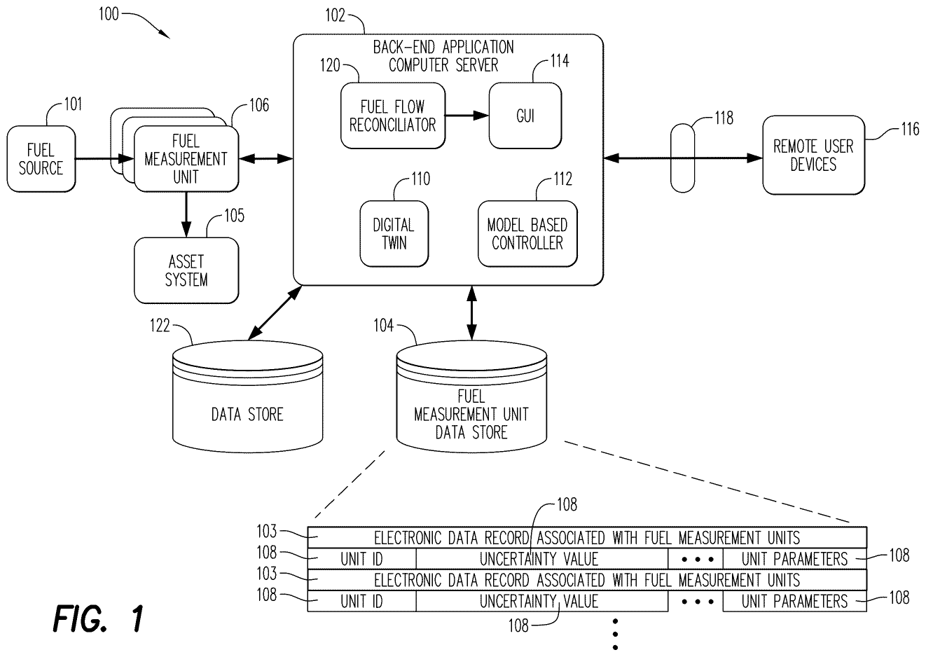

FIG. 1 is a high-level block diagram of a fuel flow reconciliation framework or system 100 according to some embodiments of the present invention. In particular, the system 100 includes a back-end application computer server 102 that may access information in fuel measurement unit data store 104 (e.g., storing a set of electronic records associated with a set of fuel measurement units 106, each record including, for example one or more fuel measurement unit parameters such as fuel unit identifier, uncertainty value, etc. and other suitable parameters).

A fuel measurement unit 106 may refer to a device or system used to quantify the amount of fuel received from a fuel source 101. The fuel measurement unit typically measures the amount of received fuel in units like gallons, liters, or cubic feet, depending on the fuel type, and can include tools like flow meters, non-flow-meter sensors, control valves and other suitable tools, designed to accurately measure fuel consumption. The fuel may be consumed by an asset system 105 (e.g., industrial asset). The asset system 105 includes, but is not limited to, industrial manufacturing equipment on a production line, wind turbines that generate electricity on a wind farm, gas turbines for aircraft propulsion and/or to produce electricity for power generation companies and/or to power compressors and pumps for resource transportation, drilling equipment, etc. The accuracy of a fuel measurement unit is critical for reliable fuel management and may be impacted by factors like temperature, pressure, and fuel quality. Each fuel measurement unit has an industry-standard uncertainty value. An uncertainty value of a measurement represents the degree of doubt or error associated with a measurement result. It is often determined by considering factors such as instrument precision, environmental conditions and statistical analysis of repeated measurements.

A flow meter is a type of sensor that detects and measures the volume of fuel flowing through a pipe (e.g., flow rate). The flow meter monitors the fuel that's coming into the system/unit via the pipeline. The flow meter translates the fluid movement into a measurable signal. A non-exhaustive example of a flow meter is an orifice meter. The orifice meter is a device consisting of an orifice plate with a hole (or a series of holes) in it, which measures how fast a fluid is flowing, by recording the pressure decrease across the hole(s). The orifice meter is often installed between two pipe flanges, and two taps that convey the high- and low-pressure values that come from a pressure tap located upstream of the face of the plate and downstream from the face of the plate. The taps are connected via an “impulse” line to a differential pressure sensing device such as a manometer, differential pressure (DP) gauge or differential pressure transmitter.

The fuel measurement unit may also be a fuel control valve. The fuel control valve regulates the flow of fuel, controlling how much fuel is delivered to the asset system 105 that produces the emissions during operation thereof. With the gas turbine, the fuel control valve controls the fuel flow to the combustor and through it. The control valve position affects the flow of fuel and may be used to estimate the fuel flow.

A digital twin 110 may be another type of fuel measurement unit 106. The digital twin 110 may reside on the back-end server 102.

A digital twin is a software representation of a physical asset, system or process designed to detect, prevent, predict and optimize through real time analytics. In an industrial operating environment, a digital representation of an asset, referred to as a digital twin, can be made up of a variety of operational technology (OT) and information technology (IT) data management systems. Examples of OT data systems include data historian services which maintain a history of sensor data streams from sensors attached to a physical asset and monitoring systems that detect and store alerts and alarms related to potential fault conditions of a physical asset. Examples of IT data systems include, but are not limited to, enterprise resource planning (ERP) systems, maintenance record databases, etc. Typically, a digital twin is used to simulate or otherwise mimic the operation of a physical asset within a virtual world. In doing so, the digital twin may virtually display structural components of the asset, show steps in lifecycle and/or design, and be viewable via a user interface.

Here, the digital twin is an emission digital twin. The emission digital twin may include one or more modules. The modules include, but are not limited to a fuel flow module, a fuel chemistry module, a gas chromatography module, etc.

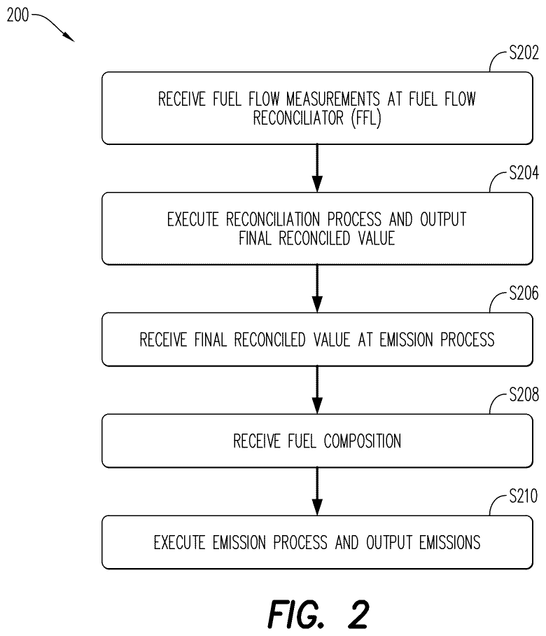

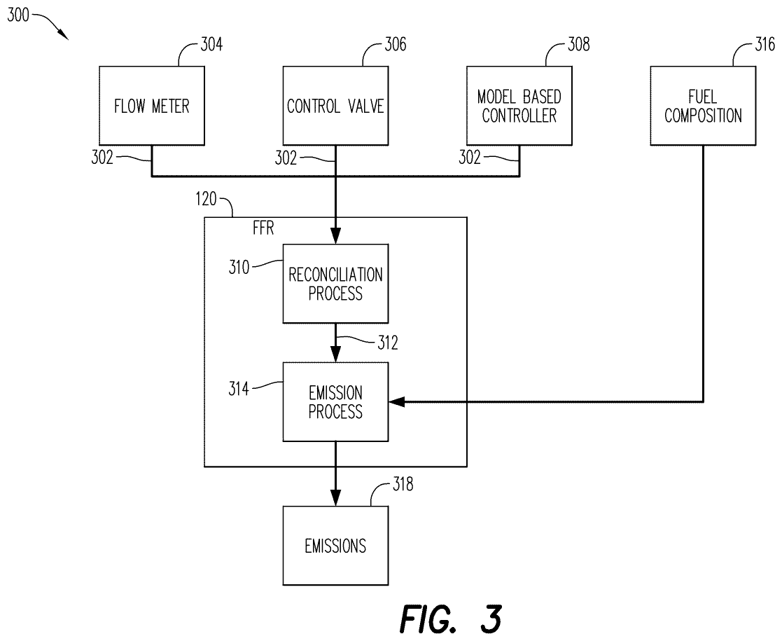

Pursuant to one or more embodiments, the fuel flow module of the digital twin 110 (referred to herein as “digital twin”) may use an Adaptive Real-time Engine Simulation (ARES) model, which is a high-fidelity model of a gas turbine, continuously tuned in real-time to match the performance of the actual gas turbine. The ARES model is coded to run real-time in a gas turbine controller. Existing gas turbine sensors are used to tune—via a heat soak model—the ARES model to match the actual operation conditions of a unit at any given moment by comparing its prediction of four key parameters (compressor discharge pressure, compressor discharge temperature, exhaust temperature, generator output (gas turbine contribution only)) to the corresponding sensed feedback. The ARES model estimates many un-measurable cycle parameters with a high degree of accuracy that can be used directly in control loops or as inputs to additional models or tools (e.g., FFR). As described further below, with respect to FIGS. 2 and 3, the ARES model of the digital twin 110 calculates a predicted amount of fuel input to/consumed by the gas turbine.

The back-end application server 102 also includes a Model Based Controller (MBC) 112. A MBC 112 is a control system that utilizes “model-based control” technology, where the system's behavior is designed and optimized based on a mathematical model of the process or equipment the MBC is controlling, allowing for more precise and adaptable control compared to traditional methods. The MBC 112 enables real-time tuning and performance optimization of the asset system 105, digital twin 110 and other models. Unlike static control schedules, model-based control leverages real-time simulations of the system to make dynamic adjustments based on changing conditions. MBC 112 in a gas turbine control system may provide for optimal combustion control, load variations management and improved efficiency. The MBC 112 may adjust the physical operation of the asset system 105 based on data received from at least one of the FFR 120 and the digital twin 110.

The back-end application computer server 102 may also exchange information with other data stores 122 and utilize a Graphical User Interface (“GUI”) 114 to view, analyze, and/or update the electronic records. The back-end application computer server 102 may also exchange information with a remote user devices/administrator platform 116 (e.g., via a firewall 118). In some embodiments, the remote user devices/administrator platform 116 may transmit annotated and/or updated information to the back-end application computer server 102. Based on the updated information, the back-end application computer server 102 may adjust data in the data store 104/122, and/or the change may be viewable via other remote user devices/administrator platforms. Note that the back-end application computer server 102 and/or any of the other devices and methods described herein might be associated with a third party.

Presentation of a user interface via the GUI 114 may include any degree or type of rendering, depending on the type of user interface code generated by the back-end application computer server 102. For example, a user (not shown) may execute a Web Browser to request and receive a Web page (e.g., in HTML format) from back-end application computer server 102 via HTTP, HTTPS, and/or WebSocket, and may render and present the Web page according to known protocols.

A fuel flow reconciliator (FFR) 120 receives fuel flow measurements from fuel flow measurement units 106 and uncertainty data from fuel measurement unit data store 104. The FFR 120 generates a unit level reconciliation for fuel flow measurements and uncertainty values based thereon, as described further below. The FFR 120 then generates a plant level reconciliation fuel flow using the unit-level reconciliation measurements and a plant meter as input. Pursuant to embodiments, the FFR 120 determines an amount of emissions produced by the asset system based on the reconciliated fuel flow and emission factors.

Fuel Measurement Unit Data Store 104 and other Data Store 122 may be any query-responsive data source or sources that are or become known, including but not limited to a SQL relational database management system. Data store 104/122 may include or otherwise be associated with a relational database, a multi-dimensional database, an Extensible Markup Language (XML) document, or any other data storage system that stores structured and/or unstructured data. The data of data store 104/122 may be distributed among several relational databases, dimensional databases, and/or other data sources. Embodiments are not limited to any number or types of data sources. A structured query language (SQL) script may be generated based on a request for data and forwarded to the data store 104/122. The data store 104/122 may execute the SQL script to return a result set based on data of the data store 104/122.

The back-end application computer server 102 may store information into and/or retrieve information from the data store 104/122. The data store 104/122 may be locally stored or reside remote from the back-end application computer server 102. As will be described further below, the data store 104/122 may be used by the back-end application computer server 102 to access and update electronic records. Although a single back-end application computer server 102 is shown in FIG. 1, any number of such devices may be included. Moreover, various devices described herein might be combined according to embodiments of the present invention. For example, in some embodiments, the back-end application computer server 102 and data store 104/122 might be co-located and/or may comprise a single apparatus and/or be implemented via a cloud-based computing environment.

The back-end application computer server 102 may be separated from or closely integrated with the data store 104/122. A closely-integrated server 102 may enable execution of services completely on the database platform, without the need for an additional server. For example, back-end application computer server 102 may provide a comprehensive set of embedded services which provide end-to-end support for Web-based applications. The services may include a lightweight web server, configurable support for Open Data Protocol, server-side JavaScript execution and access to SQL and SQLScript. The back-end application computer server 102 may provide application services (e.g., via functional libraries) using services that mange and query the database files stored in the data store 104/122. The application services can be used to expose the database data model, with its tables, views and database procedures, to clients. In addition to exposing the data model, the back-end application computer server 102 may host system services such as a search service, and the like.

The back-end application computer server 102 and/or the other elements of the system 100 might be, for example, associated with a Personal Computer (“PC”), laptop computer, tablet, smartphone, an enterprise server, a server farm, and/or a database or similar storage devices. According to some embodiments, an “automated” back-end application computer server 102 (and/or other elements of the system 100) may facilitate the automated access and/or update of electronic records. As used herein, the term “automated” may refer to, for example, actions that can be performed with little (or no) intervention by a human.

As used herein, devices, including those associated with the back-end application computer server 102 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Note that the system 100 of FIG. 1 is provided only as an example, and embodiments may be associated with additional elements or components. According to some embodiments, the elements of the system 100 automatically transmit information associated with an interactive user interface display over a distributed communication network.

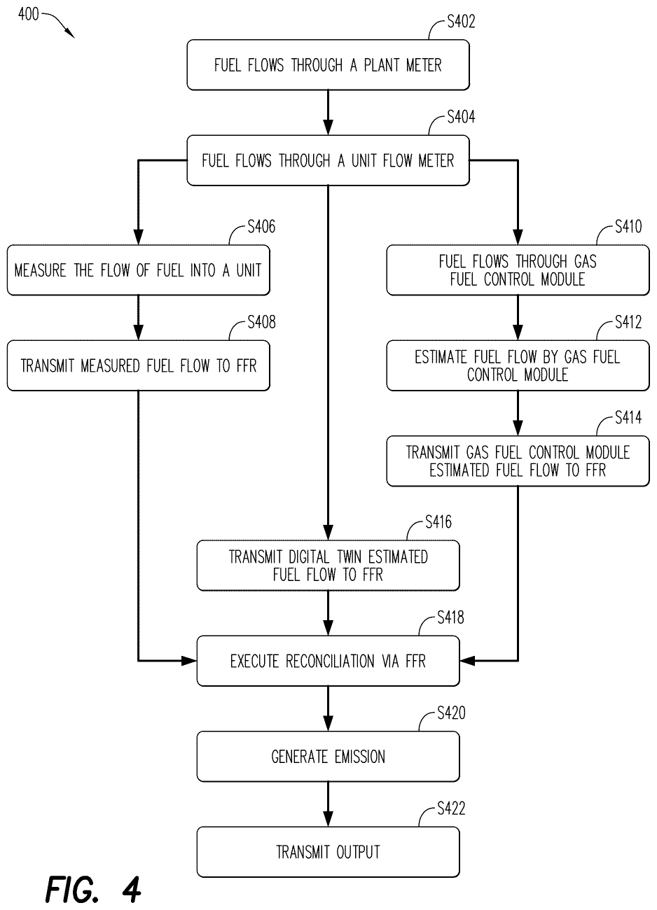

FIGS. 2 and 4 illustrate a process 200/400, respectively, that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

FIGS. 2 and 4 each comprise a flow diagram of a process 200/400 to determine an amount of emissions generated by an asset system according to some embodiments. Process 200 is a high-level description of the process, while process 400 is a more detailed description of the process. Process 200, 400 and other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Initially, at S202, fuel flow measurements are received at the Fuel Flow Reconciliator (FFL) 120. As shown in the block diagram 300 of FIG. 3, a fuel flow measurement 302 is received from each of the flow meter 304, control valve 306 and model-based controller (e.g., digital twin) 308. Then, at S204, the FFL executes a reconciliation process 310 and outputs a final reconciled fuel flow measurement value. As further below, as part of the reconciliation process 310, first the measurements from the flow meter 304 and control valve 306 are taken as inputs. The uncertainty of each input is calculated, and a reconciliation value for these two inputs is generated. Then, this reconciled value and an uncertainty for this reconciled value become the first input for the next iteration of the reconciliation process and the model-based controller 308 becomes the second input for this next iteration of the reconciliation process. The reconciliation process 310 includes a Kalman filter. A Kalman filter is a recursive estimator that takes in a series of measurements observed over time and produces an estimate of the next value based on the previously observed values, by combining predictions with new measurements (e.g., essentially “filtering out” the noise to produce the best possible estimate based on the available data). Here, the Kalman filtering is applied by first reconciling the flow meter and control valve measurements and then combining that reconciliated value with the model-based controller measurement to output the final reconciled measurement value. The Kalman filter estimates observable and unobservable parameters with great accuracy in real-time. The use of the Kalman filter in one or more embodiments provides for estimates with improved accuracy in systems (e.g., gas turbines) that operate in real time, allowing greater control of the system and thus more capabilities.

The final reconciled measurement value 312 is output by the reconciliation process 310 and received by the emission process 314 in S206. As described above, emissions are highly dependent on the amount of fuel and the content or composition of the fuel. The emission process 314 also receives fuel composition 316 in S208. The fuel composition may be determined by a fuel gas analyzer or other suitable element. Then at S210, the emission process 314 is executed and generates an emission amount 318 as output.

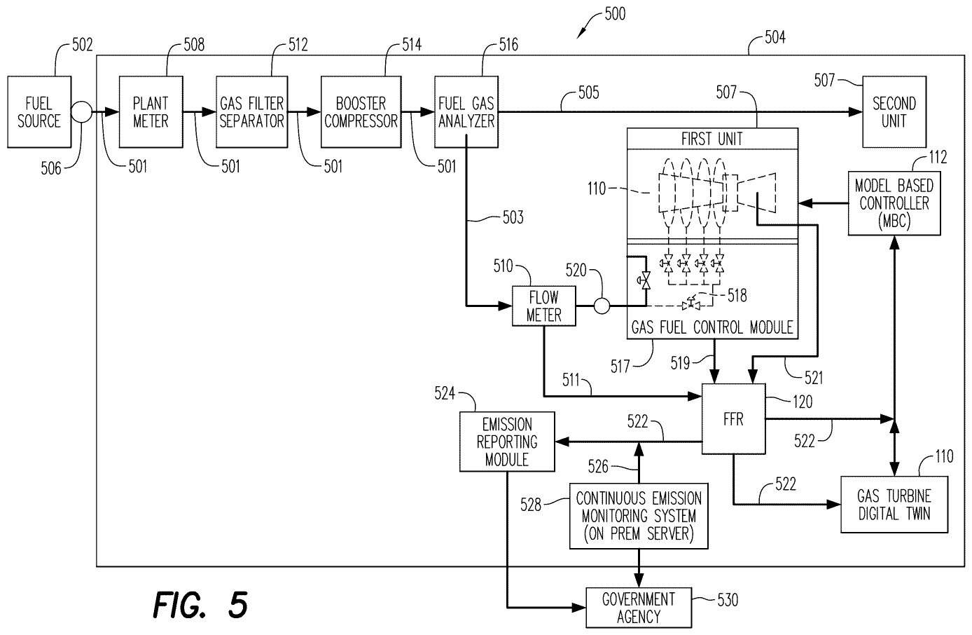

FIG. 4 is a more detailed explanation of the process 200 described in FIG. 2. Prior to the process 400, a fuel flows from a fuel source 502 through a pipeline 501 into a plant 504 via a custody transfer point 506, as shown in the block diagram 500 of FIG. 5. The plant 504 may be a power plant, or any other suitable manufacturing/asset-system plant. A non-exhaustive example of a power plant is a gas turbine power plant, which is a thermal power station that generates electricity by burning natural gas in a combustion chamber, which then drives a gas turbine to spin a generator, converting the heat energy into electrical power). The plant 504 may include one or more asset system units 507 (e.g., gas turbines). As described above, embodiments herein are described with the gas turbine as the non-exhaustive example of an asset system/units. Here, the plant 504 includes a first unit and a second unit 507.

Initially, at S402, the fuel flows from the custody transfer point 506 through a plant meter 508. The plant meter 508 may be a device that measures the flow of liquids and gases in the pipeline flowing into the plant 504. The plant meter 508 may be a Coriolis meter or other suitable meter. The Coriolis meter uses the Coriolis effect to calculate the mass flow rate, density and volume flow of the fluid. Coriolis meters are highly accurate, and eliminate the need to correct for pressure, temperature and density fluctuations. While a Coriolis meter is highly accurate, they are costly, often resulting in an enterprise limiting their use to a single point in a plant, as opposed to measuring a flow for each unit 507 in a plant.

After passing through the plant meter 508, the main pipeline 501 splits into a first unit 503 pipeline and a second unit pipeline 505, allowing the fuel to flow to both the first unit and the second unit. The main pipeline 501 may further split into n pipelines, allowing the fuel to flow to each of n units in the plant 504.

The fuel flows through a unit flow meter 510 in S404. The unit flow meters 510 may be stationed at particular locations in the plant. The fuel flows through each unit flow meter 510. While S404-S420 are described with respect to the first unit, these steps apply to each unit in the plant 504. The unit flow meter 510 measures the actual flow of fuel into the unit in S406. Here, the unit flow meter 510 measures the fuel flow into unit 1. The unit flow meter 510 transmits the measured fuel flow 511 to the FFR 120 in S408.

It is noted that in some embodiments, the fuel may flow directly from the main pipeline 501 to any unit pipelines, while in other embodiments, the fuel may flow through one or more devices on the main pipeline 501 prior to flowing to the unit pipelines.

Continuing with the non-exhaustive example in FIG. 5 for the gas turbine plant, after passing through the plant meter 508, the fuel flows through a gas filter separator 512. The gas filter separator 512 removes fine-to-medium sized solid and liquid contaminants from the fuel. From the gas filter separator 512, the fuel flows into a booster compressor 514. The booster compressor 514 increases the pressure of the fuel to meet the needs of the application that requires high pressure. In a gas turbine power plant, for example, the booster compressor boosts the existing pressure to a significantly higher pressure to supply the fuel at the necessary pressure. Next, the fuel flows into a fuel gas analyzer 516. The fuel gas analyzer 516 measures the composition of the fuel gas. Here, the fuel gas analyzer measures the composition of the fuel gas being used to operate the turbine, allowing operators to monitor key parameters like the concentration of hydrocarbons, methane and other components to ensure optimal combustion efficiency including maximizing energy production and minimizing harmful emissions and fuel waste by adjusting the fuel-air ratio.

Continuing with the process 400, after the fuel flows through the unit flow meter 510, the fuel flows into a gas fuel control module 517 including one or more fuel control valves 518 at S410. As described above, the fuel control valves 518 control how much fuel is delivered to the asset system 105 (e.g., here the gas turbine) based on a fuel control valve position. Often, the fuel control valve has two primary positions: “closed” (fully shut off) and “open,” allowing fuel flow to the combustion chamber of the gas turbine, with the valve's position dynamically adjusting between the extremes to regulate the fuel flow based on the engine's operating conditions (like power demand and speed) as determined by a control system (e.g., MBC). The fuel control valve may also have multiple secondary positions between the extreme primary positions of “open” and “closed”. The dynamic adjustment may have the fuel control valve physically opening further or closing further to the secondary positions. Non-exhaustive factors influencing the fuel control valve position are engine speed (e.g., as engine speed increases, the fuel control valve typically opens further to support more fuel for combustion), load demand (e.g., higher power demands require a more open fuel control valve to deliver increased fuel) and engine control system signals (e.g., electronic signals from the engine control unit determine the necessary valve positions based on various parameters like pressure, temperature, and desired power output).

Then at S412, the fuel flow at the gas fuel control module 517 is estimated. Pursuant to embodiments, the gas fuel control module 517 identifies the control valve position. The gas fuel control module 517 estimates the fuel flow based on a mapping (not shown) of the control valve position 518 to an estimated fuel flow.

The estimated fuel flow 519 per the gas fuel control module 517 is transmitted to the FFR 120 in S414.

It is noted that the transmission of the measurements to the FFR 120 in S406 may occur at the same time as, or substantially the same time as, or at a different time from, the fuel flow into the one or more gas control valve 518 at S410. Pursuant to some embodiments, the plant 504 may include a safety shut-off valve 520 between the unit flow meter 510 and the gas fuel control module 517. S410 occurs in a case the safety shut-off valve 520 has not been triggered to ensure the shutoff of fuel to the gas turbine.

Then, at S416, a digital twin estimated fuel flow 521 is transmitted to the FFR 120 from the fuel flow module of the digital twin 110. It is noted that transmission of the digital twin estimated fuel flow in S416 may occur at the same time as, or substantially the same time as, or at a different time from, the transmission of the measured fuel flow to the FFR 120 at S408 and/or and of S410-S414.

Next, at S418, the FFR 120 executes the reconciliation based on the received measurement in S408, gas fuel control module estimation in S414 and the digital twin estimation in S416. The output of the reconciliation at S418 is a reconciled unit level fuel flow with a reconciled uncertainty. The FFR 120 then, in S420, generates the emissions using the reconciled unit level fuel flow and an emission factor as an input. The FFR output 522 includes at least the output of the reconciliation (e.g., reconciled unit level fuel flow with a reconciled uncertainty) and the generated emissions.

Execution of the reconciliation includes the aggregation of measurements and uncertainties from the same measurement made by (and associated with) different fuel measurement units. Execution of the reconciliation includes the FFR 120 passing through measurements iteratively, where the first two inputs are taken for the flow meter and control valve, the uncertainty of each of these inputs is calculated, and a reconciliation value is calculated for these two inputs. Then this reconciliated value and uncertainty becomes the input for the next iteration with the third input (digital twin measurement). The output of this next iteration is the final reconciled value and uncertainty.

Pursuant to embodiments, the reconciliation includes the following four equations;

$$ε = {\sum }_{i = 1}^{a} \{ \frac{\partial f ( {x}_{i} )}{\partial {x}_{i}} \cdot Δ {x}_{i} \} = {\sum }_{i = 1}^{n} \{ {S}_{j} \cdot Δ {x}_{i} \} \qquad Equation 1$$

$${U}_{e} = {\{ {\sum }_{i = 1}^{n} {( \frac{\partial f ( {x}_{i} )}{\partial {x}_{i}} \cdot {U}_{i} )}^{2} \}}^{1 / 2} = {\{ {\sum }_{i = 1}^{n} {( {S}_{i} \cdot {U}_{i} )}^{2} \}}^{1 / 2} \qquad Equation 2$$

$${x}_{i}^{a} = {x}_{i} - \frac{{( {S}_{i} \cdot {U}_{i} )}^{2}}{{U}_{ε}^{2}} \cdot \frac{f ( {x}_{i} )}{{S}_{i}} \qquad Equation 3$$

$${( {U}_{i}^{a} )}^{2} = ( 1 - {w}_{i} ) \cdot {U}_{i}^{2} \qquad Equation 4$$

where (xᵢ) is the measurement value/estimation from one of: 1. a flow meter, 2. a control valve and 3. a digital twin; (Sᵢ) is the standard deviation; (Uᵢ) is the measurement uncertainty for the given flow measurement unit, and (wᵢ) is the weight assigned to the individual uncertainty. These variables are used to calculate (x*ᵢ), which is the best estimate of the true value of the actual measurement (xᵢ), and (U*), which is the uncertainty of (x*ᵢ). It is noted that uncertainty (U*) of (x*ᵢ) is less than the original measurement uncertainty (U) of (x) and uncertainty (U*) of (x*ᵢ) is the overall minimum possible uncertainty. In the reconciliation, first Equation 1 is executed to output an aggregation of the standard deviations of the measurements from each of the flow meter, the control valve and the digital twin. For each measurement, the standard deviation is multiplied by a difference between the actual measurement value and a difference between the actual measurement value and the standard deviation. Then, Equation 2 is executed to output an aggregation of the uncertainty (Uᵢ) for each of the flow meter, the control valve and the digital twin. Here: 1. each uncertainty value for a respective measurement unit is multiplied by the standard deviation for that measurement, 2. that value is squared, 3. the squared values for each measurement unit are aggregated, and 4. a square root of the aggregated value is executed. Next, using at least the output of Equation 2, the standard deviation and the actual measurement value/estimation, Equation 3 is executed to output the best estimate of the true value of the actual measurement. The uncertainty of the best estimate is executed via Equation 4, using the manufacturer-provided weight. The uncertainty of the best estimate (e.g., final uncertainty) is executed using It is noted that Equation 3 and Equation 4 may be processed in parallel or in any suitable order.

The weights are based on the overall accuracy of the given fuel measurement unit, such that the weights are decided based on how much lower the uncertainty is that the measurement is accurate for each form of measurement. As a non-exhaustive example, the Coriolis flow meter (e.g., plant meter 508) has a very low uncertainty value, so this type of fuel measurement unit is assigned a higher weight. The weights are assigned to the fuel measurement units prior to execution of the process 400, and the assigned weights are stored in the records of the fuel measurement unit data store 104.

The inventors note that if only one fuel measurement unit is used, the uncertainty assigned to that fuel measurement unit is the uncertainty applied to the measurement. By using three different measurement units, there are three different uncertainties, and the reconciliation generated with the weights typically results in a lower uncertainty than the uncertainty for each individual fuel measurement unit.

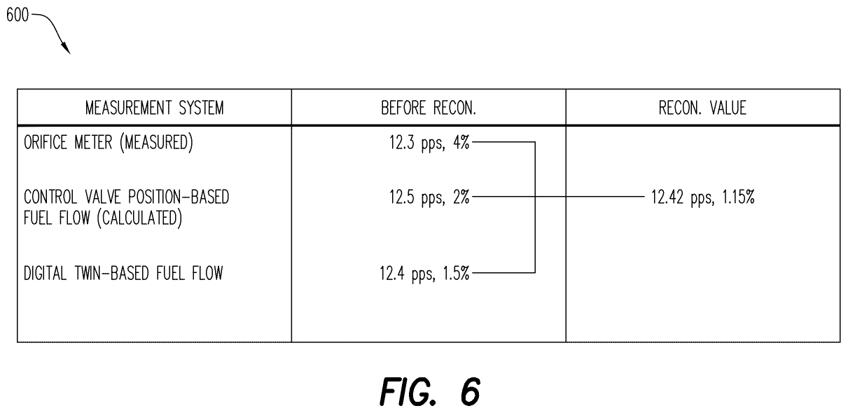

Consider the non-exhaustive example of a unit level fuel flow reconciliation in the table 600 of FIG. 6. Here, the flow meter has a measurement of 12.3 pps with an uncertainty of 4%, the control valve position based fuel flow has an estimated measurement of 12.5 pps with an uncertainty of 2% and the digital twin has an estimated fuel flow measurement is 12.4 pps, with an uncertainty of 1.5%. After execution of the FFR 120 which uses the weighted sum, the reconciled fuel flow of the unit 1 gas turbine is 12.42 pps, with an uncertainty of 1.15%.

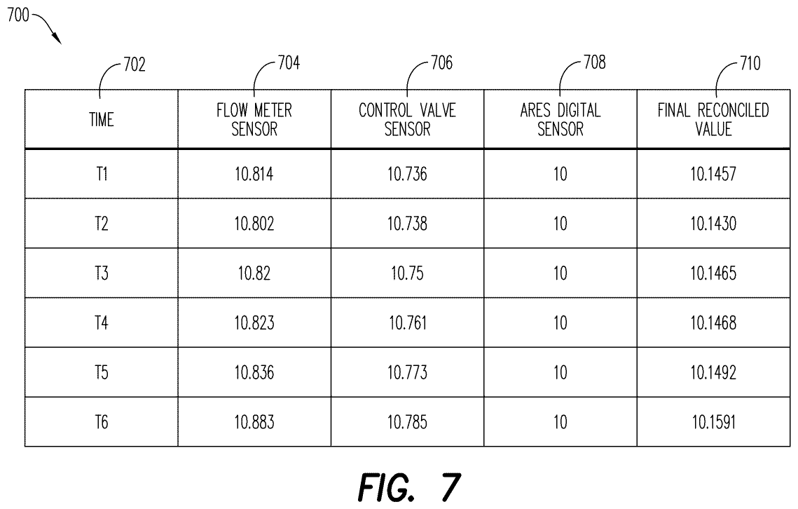

Pursuant to embodiments, the fuel measurement unit may measure the data in a time series in a standard format. The reconciliation at S418 may be executed for the measured/calculated/estimated value at each time stamp in the time series. As a non-exhaustive example, FIG. 7 includes a table 700 of time series measurements for each of the measurement units. Here, the table includes a plurality of individual time stamps 702 (e.g., T1, T2, T3, T4, etc.) that together form a time series. For each individual time stamp, there are values for each of the following parameters: a flow meter sensor 704, a control valve sensor 706, and an ARES Digital Sensor 708. Embodiments generate a final reconciled value 710 for each time stamp. It is noted that for ease of explanation, measurements/estimates are described for a single time stamp. However, in practice, the measurements/estimations may be recorded every minute and the reconciliation generated for each time stamp, making the unit-level reconciliation one that cannot practically be performed in the human mind. Furthermore, these measurements are for a single unit and a plant may include multiple units, also making a plant-level reconciliation one that cannot practically be performed in the human mind.

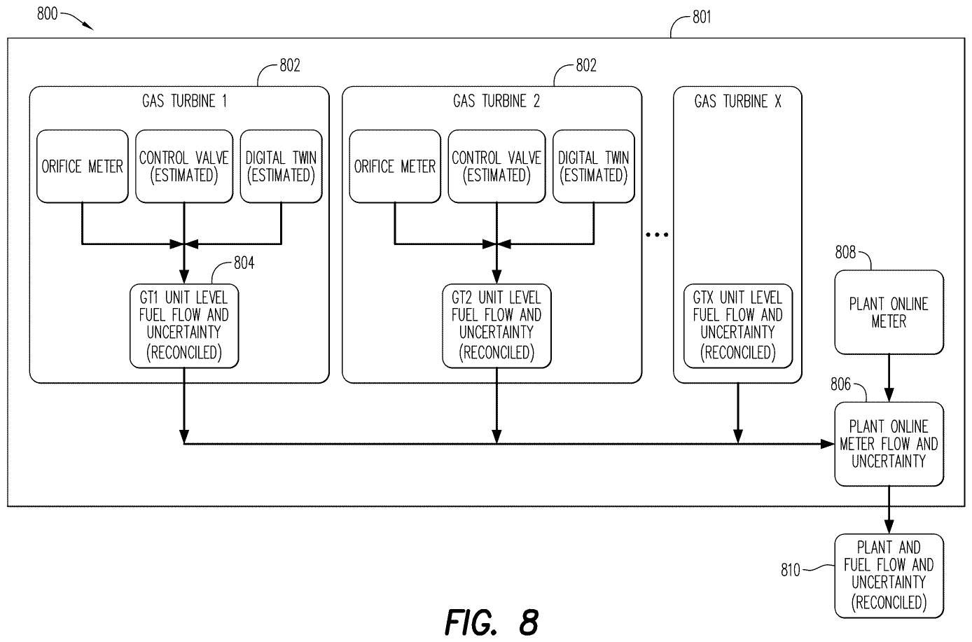

In one or more embodiments, the reconciled unit level fuel flows and uncertainty for each unit is combined with a measurement and uncertainty of the plant meter 508 to generate a plant level fuel flow and uncertainty reconciliation 810, as shown in the block diagram 800 of FIG. 8. Here, the plant 801 includes multiple assets 802—Gas Turbine (GT) 1, Gas Turbine (GT) 2, . . . Gas Turbine (GT) X. Similarly to how the three fuel measurement unit values for each of the gas turbines are reconciled in S418 to generate the reconciled fuel flow and uncertainty for each unit (unit-level fuel flow (reconciled) 804), the unit-level fuel flow and uncertainty (reconciled) 804 for each unit in the plant 801 is combined with the measurement and uncertainty 806 of the plant meter 808. Using the same Equations 1, 2, 3, and 4 as in the unit-level reconciliation, such that for the plant-level reconciliation, the (xᵢ) is now the unit-level measurement (reconciled) for each asset system (gas turbine) and the uncertainty is the reconciled uncertainty for that reconciled measurement unit.

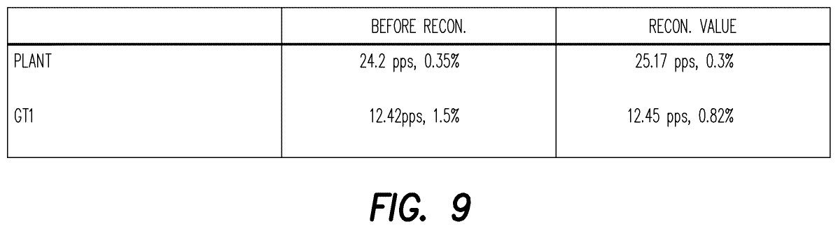

Continuing with the non-exhaustive example described above with respect to FIG. 6, in the case of a plant level fuel flow reconciliation, the table 900 of FIG. 9 shows the plant measurement and uncertainty went from 25.2 pps and 0.35%, respectively, to a reconciled measurement and uncertainty of 25.17 pps and 0.3%, respectively. Then, that 0.3% uncertainty may be applied to each of the reconciled unit-level measurements and uncertainties. As such, for the GT1 (which is the example in FIG. 6), the reconciled uncertainty of 1.15% is reduced via application of 0.3% to be 0.82% (e.g., taking rounding into account). Application of the plant level fuel flow reconciliation results in reduced uncertainties and improved accuracy for the units.

Turning back to the process 400, after the reconciliation is executed at S418 to generate the output of a reconciled unit level fuel flow with a reconciled uncertainty, and the emission is generated in S420, the FFR output 522 is transmitted in S422. The output is transmitted to at least the model based controller (MBC) 112, the digital twin 110, and an emission reporting module 524. The FFR 120 output 522 may be generated and transmitted in real time.

As described above, the MBC 112 receives the output of the FFR 120 and dynamically adjusts the operation of the asset system (e.g., gas turbine) based on the FFR output 522. As a non-exhaustive example, the MBC 112 adjusts the combustion control (e.g., fuel and air flow) for the gas turbine based on the more accurate fuel flow measurement. Combustion control refers to the management of the air-to-fuel ratio in a combustion process, ensuring efficient burning by maintaining the optimal balance of fuel and oxygen; it involves monitoring and physically adjusting fuel and air flow based on fuel and air data to achieve desired combustion conditions. As another non-exhaustive example, the MBC 112 adjusts load variations per load variations management based on the more accurate fuel flow measurement. Load variations management in a gas turbine refers to the process of actively controlling the power output of the turbine by adjusting fuel flow via adjustment of mechanical elements and other parameters to respond to changing power demands. The more accurate fuel flow allows the MBC to operate the turbine more efficiently. The MBC 112 also receives output from the digital twin 110 and may adjust operation of the gas turbine based on the digital twin output. The MBC 112 may also report feedback to the digital twin 110 based on operation of the gas turbine. The MBC 112 may use the FFR output 522 and digital twin output to adjust operation of the gas turbine.

The digital twin 110 receives the FFR output 522 and is better able to predict how much emission is produced (e.g., how many tons of carbon dioxide are produced). The reduced uncertainty from the FFR output 522 provides for much better predictions of carbon dioxide and nitrogen oxides (e.g., emissions) produced from running the asset.

The emission reporting module 524 receives the FFR output 522 and output 526 from a Continuous Emission Monitoring System (CEMS) 528. The emission reporting module 524 may generate a report at any suitable time interval (e.g., monthly, yearly, etc.) and/or on demand. The report may be transmitted to government agencies 530, the enterprise itself, shareholders or any other suitable third party.

As described above, the CEMS 528 is a set of equipment that measures the amount of gas or particulate matter emitted from an industrial process. CEMS 528 may be mandated by a government agency 530 and is used to ensure compliance with environmental regulations. The CEMS 528 uses pollutant analyzers to measure the concentration of emissions, and then converts the measurements into units that are comparable to emission standards. The CEMS 528 calculates emission rates to determine if the standards are being met. The CEM output 526 includes the emission rate and an indication if government limits and standards are being met. As such, the CEMS 528 measures emissions whenever the asset system runs, and the CEMS 528 reports the CEM output 526 to at least one of the emission reporting module 524 and one or more government agencies 530 (e.g., Environmental Protection Agency (EPA), Energy Information Administration (EIA)). A pull mechanism may pull the data from the CEMS 528 at a government-agency set frequency and store the data in a government agency database.

The inventors note that the CEMS measurements have an uncertainty of about five percent (5%) for the emission determination, while pursuant to embodiments, the unit-level uncertainty after the reconciliation is less than 2% (e.g., the non-exhaustive example above has a reconciled unit-level uncertainty of 1.15%) and the uncertainty is the same for the generated emissions. As such, embodiments provide a more accurate measure of emissions than are required by government regulations. For example, using the reconciled 2% in the digital twin makes the digital twin more accurate at predicting emission output than the CEMS 528.

The process 400 may be executed at any suitable interval (e.g., once an hour, three times an hour, once a minute, etc.). The interval may be based on the frequency of the data being received. It is noted that government regulations may dictate the frequency with which data is being received by the CEMS 528, and the process 400 may be executed at similar/same intervals, such that the intervals for execution of the process depend on the frequency of the CEMS collecting data.

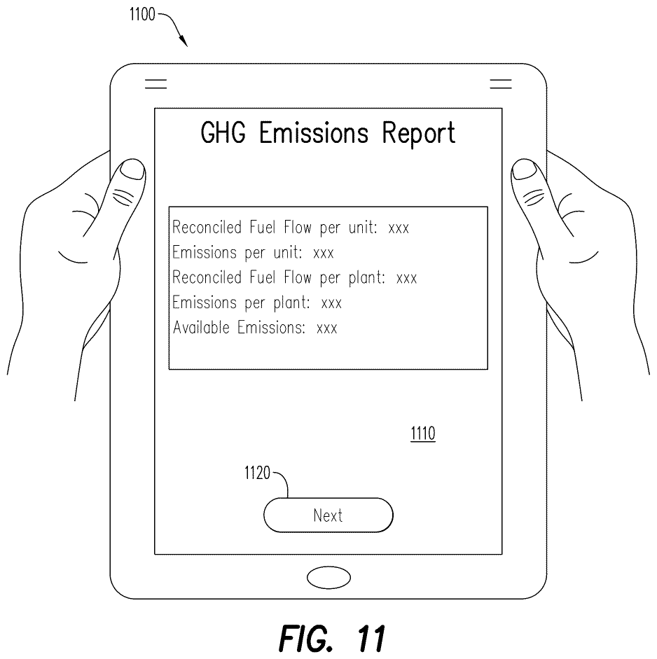

Pursuant to embodiments, the report (a display of which is shown in FIG. 11) generated by the emission reporting module 524 may include the generated emissions for a given period of time, and the generated emissions relative to a government threshold. Based on the comparison of the reconciled measurement of emissions to the government threshold, the enterprise may adjust the operation of the emission producing asset systems (e.g., if the enterprise has seven gas turbines and four are reaching their entitlement for the emission cap, the enterprise may not be able to run all of the turbines at the same output).

The reconciled emissions relative to the government threshold may be used for carbon trading. With respect to carbon trading, the generated report indicates a low uncertainty measurement of emissions, and a government cap indicating the amount of emissions the enterprise is allotted to emit. The amount of emissions allotted to the enterprise may be referred to as “credits”. Based on the comparison of the reconciled measurement of emissions to the government cap, the enterprise may be emitting less than the government cap and may sell their credits or the enterprise may be emitting more than the government cap and may buy credits from another enterprise.

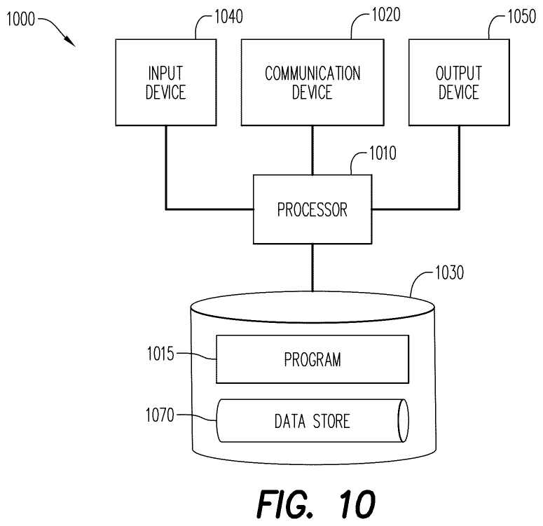

The embodiments described herein may be implemented using any number of different hardware configurations. For example, FIG. 10 illustrates an apparatus 1000 that may be, for example, associated with system 100 described with respect to FIG. 1. The apparatus 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote third-party platforms, administrator computers, and/or communication devices (e.g., PCs and smartphones). Note that communications exchanged via the communication device 1020 may utilize security features, such as those between a public internet user and an internal network of an enterprise. The security features might be associated with, for example, web servers, firewalls, and/or PCI infrastructure. The apparatus 1000 further includes an input device 1040 (e.g., a mouse and/or keyboard to enter information about fuel measurement units, asset systems, etc.) and an output device 1050 (e.g., to output reconciled fuel measurements, reconciled uncertainties, generated emissions, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or an application for controlling the processor 1010. The processor 1010 performs instructions of the program 1015, and thereby operates in accordance with any of the embodiments described herein. For example, the processor 1010 may receive a request to reconciled fuel flow for a given data point and executes the FFR.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

In some embodiments (such as shown in FIG. 10), the storage device 1030 further includes a data store 1070. It is noted that various databases might be split or combined in accordance with any of the embodiments described herein. For example, the data store 1070 might be combined and/or linked with another database within the program 1015.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., the databases described herein may be combined or stored in external systems). Moreover, although embodiments have been described with respect to specific types of entities, embodiments may instead be associated with other types of enterprises in addition to and/or instead of those described herein. Similarly, the displays and devices illustrated herein are only provided as examples, and embodiments may be associated with any other types of user interfaces. For example, FIG. 11 illustrates a tablet computer 1100 with a GHG Emissions Report display 1110 according to some embodiments. The report display 1110 includes a reconciled fuel flow per unit, an emissions based on a reconciled fuel flow per unit, a reconciled fuel flow per plant, an emissions based on a reconciled fuel flow per plant, and an available emissions per the government cap. Selection of the “Next” icon 1120 might result in transmission of the report to another party.

The present invention has been described in terms of several embodiments solely for the purpose of illustration. Persons skilled in the art will recognize from this description that the invention is not limited to the embodiments described but may be practiced with modifications and alterations limited only by the spirit and score of the appended claims.

What is claimed is:

1. A system comprising:
a data store storing an electronic record for each of a plurality of fuel measurement units, wherein each electronic record includes an uncertainty value for the fuel measurement unit;
a memory storing processor-executable program code; and
a processing unit to execute the processor-executable program code to cause the system to:
receive fuel flow data from three types of fuel measurement units, wherein the fuel is flowing from a fuel source to an asset system;
generate a reconciled fuel flow for the asset system using the received fuel flow data from the three types of fuel measurement units;
generate a reconciled uncertainty value for the asset system using the uncertainty value for the respective fuel measurement units; and
generate an emission value for the asset system based on the reconciled fuel flow.

2. The system of claim 1, wherein the three types of fuel measurement units are: a flow meter, a control valve, and a digital twin.

3. The system of claim 1, wherein the reconciled uncertainty value is less than the uncertainty value for each of the fuel measurement units.

4. The system of claim 1, wherein the received fuel flow data is time-series data.

5. The system of claim 1, wherein each fuel measurement unit has an assigned weight based on the uncertainty value.

6. The system of claim 5, wherein generation of the reconciled fuel flow for the asset system applies the assigned weight to the received fuel flow data.

7. The system of claim 1, further comprising program code to cause the system to:
transmit the reconciled fuel flow to a model based controller.

8. The system of claim 7, further comprising program code to cause the system to:
physically alter operation of the asset system via the model based controller based on the reconciled fuel flow.

9. The system of claim 1, further comprising program code to cause the system to:
receive the reconciled fuel flow and the reconciled uncertainty value for each of a plurality of asset systems in a plant;
receive fuel flow data from a plant meter;
receive an uncertainty value for the plant meter; and
generate a plant-level reconciled fuel flow.

10. The system of claim 1, wherein the asset system is one of a gas turbine, wind turbine, transportation vehicle, mining equipment, and industrial manufacturing equipment.

11. A computer-implemented method comprising:
receiving fuel flow data from three types of fuel measurement units, wherein the fuel is flowing from a fuel source to an asset system;
generating a reconciled fuel flow for the asset system using the received fuel flow data from the three types of fuel measurement units;
generating a reconciled uncertainty value for the asset system using the uncertainty value
for the respective fuel measurement units;
generating an emission value for the asset system based on the reconciled fuel flow; and
transmitting the reconciled fuel flow to a model based controller.

12. The method of claim 11, wherein the three types of fuel measurement units are: a flow meter, a control valve, and a digital twin.

13. The method of claim 11, wherein the reconciled uncertainty value is less than the uncertainty value for each of the fuel measurement units.

14. The method of claim 11, further comprising:
physically altering operation of the asset system via the model based controller based on the reconciled fuel flow.

15. The method of claim 11, further comprising:
receiving the reconciled fuel flow and the reconciled uncertainty value for each of a plurality of asset systems in a plant;
receiving fuel flow data from a plant meter;
receiving an uncertainty value for the plant meter; and
generating a plant-level reconciled fuel flow.

16. The method of claim 11, wherein the asset system is one of a gas turbine, wind turbine, transportation vehicle, mining equipment, and industrial manufacturing equipment.

17. One or more non-transitory, computer-readable medium storing instructions, that, when executed by a computing system, cause the computing system to perform operations comprising:
receiving fuel flow data from three types of fuel measurement units, wherein the fuel is flowing from a fuel source to an asset system;
generating a reconciled fuel flow for the asset system using the received fuel flow data from the three types of fuel measurement units;
generating a reconciled uncertainty value for the asset system using the uncertainty value
for the respective fuel measurement units;
generating an emission value for the asset system based on the reconciled fuel flow; and
transmitting the reconciled fuel flow to a model based controller.

18. The medium of claim 17, wherein the three types of fuel measurement units are: a flow meter, a control valve, and a digital twin.

19. The medium of claim 17, further comprising:
physically altering operation of the asset system via the model based controller based on the reconciled fuel flow.

20. The medium of claim 17, further comprising:
receiving the reconciled fuel flow and the reconciled uncertainty value for each of a plurality of asset systems in a plant;
receiving fuel flow data from a plant meter;
receiving an uncertainty value for the plant meter; and
generating a plant-level reconciled fuel flow.
